(19) United States
(12) Patent Application Publication
(10) Pub. No.: US 2023/0198437 A1
(43) Pub. Date: Jun. 22, 2023

(54) DRIVE DEVICE OF SYNCHRONOUS MOTOR AND METHOD OF DRIVING SYNCHRONOUS MOTOR

(71) Applicant: Hitachi Astemo, Ltd., Hitachinaka-shi, Ibaraki (JP)

(72) Inventors: Hiroaki SATO, Tokyo (JP); Shigehisa AOYAGI, Tokyo (JP); Shigeyuki NONOMURA, Hitachinaka-shi (JP); Hirokazu MATSUI, Hitachinaka-shi (JP)

(73) Assignee: Hitachi Astemo, Ltd., Hitachinaka-shi, Ibaraki (JP)

(21) Appl. No.: 17/926,389

(22) PCT Filed: Feb. 5, 2021
(86) PCT No.: PCT/JP2021/004253

§ 371 Date: Nov. 18, 2022

(30) Foreign Application Priority Data
May 27, 2020 (JP) 2020-092537

(51) Int. Cl. H02P 21/18; H02P 21/22

(52) U.S. Cl. CPC H02P 21/18; H02P 21/22; H02P 2207/05

(57) ABSTRACT

A drive device of a synchronous motor includes a power converter that drives the synchronous motor by sequentially applying positive and negative voltages to respective phases of the synchronous motor; a current detection unit that detects a phase current; and a magnetic pole position estimation unit estimating a magnetic pole position of a rotor based on the phase current. The magnetic pole position estimation unit acquires maximum and minimum values of the phase current while the synchronous motor is stopped, calculates a first magnetic pole position from a subtracted value of an absolute value of the maximum and minimum values, calculates a second magnetic pole position from an added value of the absolute value of the maximum and minimum values, discriminates a polarity of a magnet of the rotor, and estimates an initial magnetic pole position of the rotor from the polarity and the second magnetic pole position.

### TECHNICAL FIELD

The present invention relates to a drive device of a synchronous motor and a method of driving the synchronous motor.

### BACKGROUND ART

A permanent magnet synchronous motors (hereinafter, referred to as a synchronous motor) is used, for example, as main motors in an electric vehicle due to advantages such as high efficiency, high power factor, and low maintenance cost. In order to control such a synchronous motor, a power converter which is an inverter is used. Also, in order to control a torque and a speed of the synchronous motor by the power converter, it is required to accurately know a position of a magnetic pole of a rotor of the synchronous motor.

As a method for detecting the position of the magnetic pole of the rotor, there is a method of estimating the magnetic pole position of the rotor by applying a voltage vector. In this case, in the electric vehicle, it is required to estimate an initial magnetic pole position of the rotor while the synchronous motor is stopped with high accuracy.

PTL 1 discloses a technique of applying a voltage vector to each of three phases (a U phase, a V phase, and a W phase) of a synchronous motor and estimating an initial magnetic pole position of a rotor based on a current generated by the application of the voltage vector.

### CITATION LIST

### Patent Literature

PTL 1: JP 2016-171741 A

### SUMMARY OF INVENTION

### Technical Problem

In PTL 1, a magnetic saturation characteristic of a synchronous motor is used. However, a degree of magnetic saturation does not always occur in a sinusoidal shape with respect to the initial magnetic pole position. In general, it is known that a magnetic flux in an N-pole direction of a permanent magnet used for a rotor of a synchronous motor and a magnetic flux in a direction orthogonal thereto interfere with each other, and due to this, magnetic saturation occurs in a sinusoidal shape distorted with respect to an initial magnetic pole position. For example, due to the influence of interference, magnetic saturation may occur more when the initial magnetic pole position is near the U phase than when the initial magnetic pole position coincides with the U phase. In particular, a synchronous motor used as a main motor in an electric vehicle is required to be downsized, and thus often has such characteristics. Therefore, the technique described in PTL 1 has a problem that a large error occurs in the estimation of the initial magnetic pole position of the rotor.

### Solution to Problem

According to the present invention, a drive device of a synchronous motor includes a power converter that drives the synchronous motor by sequentially applying positive and negative voltages to respective phases of the synchronous motor; a current detection unit that detects a phase current flowing through the synchronous motor; and a magnetic pole position estimation unit that estimates a magnetic pole position of a rotor of the synchronous motor based on the phase current detected by the current detection unit, in which the magnetic pole position estimation unit acquires a maximum value and a minimum value of the phase current while the synchronous motor is stopped, calculates a first magnetic pole position from a subtracted value of an absolute value of each of the maximum value and the minimum value, calculates a second magnetic pole position from an added value of the absolute value of each of the maximum value and the minimum value, discriminates a polarity of a magnet of the rotor from the first magnetic pole position, and estimates an initial magnetic pole position of the rotor of the synchronous motor from the polarity and the second magnetic pole position.

According to the present invention, a method of driving a synchronous motor by a drive device of the synchronous motor that includes a power converter that drives the synchronous motor by sequentially applying positive and negative voltages to respective phases of the synchronous motor, and a current detection unit that detects a phase current flowing through the synchronous motor, includes: acquiring a maximum value and a minimum value of the phase current detected by the current detection unit while the synchronous motor is stopped; calculating a first magnetic pole position from a subtracted value of an absolute value of each of the maximum value and the minimum value; calculating a second magnetic pole position from an added value of the absolute value of each of the maximum value and the minimum value; discriminating a polarity of a magnet of the rotor of the synchronous motor from the first magnetic pole position; and estimating an initial magnetic pole position of the rotor of the synchronous motor from the polarity and the second magnetic pole position.

### Advantageous Effects of Invention

According to the present invention, an initial magnetic pole position of a rotor of a synchronous motor can be estimated with high accuracy while the synchronous motor is stopped.

### BRIEF DESCRIPTION OF DRAWINGS

FIG. 1 is a configuration diagram of a drive device according to a first embodiment.

FIG. 2 is a detailed configuration diagram of a voltage pulse generation unit according to the first embodiment.

FIG. 3 is a diagram illustrating a relationship between three-phase voltage commands and three-phase currents according to the first embodiment.

FIG. 4 is a detailed configuration diagram of a magnetic pole position estimation unit according to the first embodiment.

FIG. 5 is a detailed configuration diagram of a magnetic pole position estimation unit according to a second embodiment.

FIG. 6 is a detailed configuration diagram of a position estimator according to the second embodiment.

FIG. 7 is a configuration diagram of a drive device according to a third embodiment.

### DESCRIPTION OF EMBODIMENTS

Hereinafter, embodiments of the present invention are described with reference to the drawings. The following description and drawings are examples for describing the present invention, and are omitted and simplified as appropriate for the sake of clarity of description. The present invention can be carried out in various other forms. Unless otherwise specified, each component may be singular or plural.

### First Embodiment

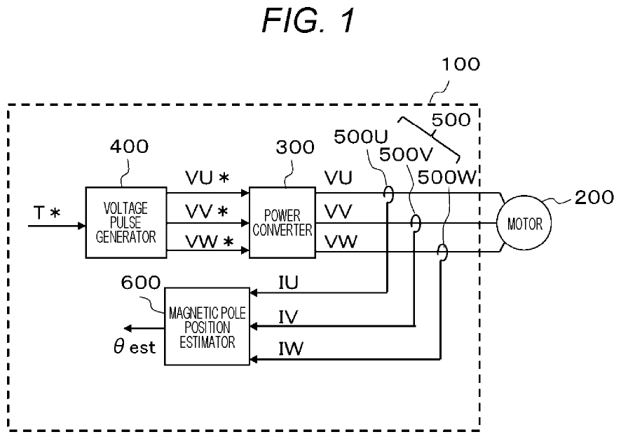

FIG. 1 is a configuration diagram of a drive device 100 according to the present embodiment.

The drive device 100 includes a power converter 300, a voltage pulse generation unit 400, a current detection unit 500, and a magnetic pole position estimation unit 600, and drives a synchronous motor 200.

The synchronous motor 200 is a permanent magnet-type synchronous motor and includes a permanent magnet (ferromagnetic body) as a rotor and an armature winding as a stator. In the present embodiment, a position sensor that detects a magnetic pole position of the synchronous motor 200 is not provided, but the magnetic pole position is estimated instead. In the case of estimating the magnetic pole position, downsizing, cost reduction, and reliability improvement of the synchronous motor 200 can be achieved.

When the synchronous motor 200 is driven, the voltage pulse generation unit 400 generates voltage commands VU*, VV*, and VW* for sequentially applying positive and negative voltages to a U phase, a V phase, and a W phase of the synchronous motor 200 in response to an input torque command T*, and outputs the generated commands to the power converter 300. The voltage pulse generation unit 400 generates the voltage commands VU*, VV*, and VW* based on the magnetic pole position estimated by the magnetic pole position estimation unit 600.

The power converter 300 is, for example, an inverter, and performs pulse width modulation (PWM) on the voltage commands VU*, VV*, and VW* from the voltage pulse generation unit 400 to turn on/off a semiconductor switch element of the power converter 300 when the synchronous motor 200 is driven. As a result, voltages VU, VV, and VW are applied to the synchronous motor 200 to drive the synchronous motor 200.

The current detection unit 500 includes current sensors 500U, 500V, and 500W that detect three-phase currents flowing through the synchronous motor 200. The current sensors 500U, 500V, and 500W are arranged for respective phases of the synchronous motor 200. The current detection unit 500 detects three-phase currents IU, IV, and IW and outputs the three-phase currents IU, IV, and IW to the magnetic pole position estimation unit 600. Although an example in which the current sensors 500U, 500V, and 500W are arranged for the respective three phases of the synchronous motor 200 is provided, the current sensors may be arranged only for two phases (for example, the U phase and the V phase) by utilizing the fact that the sum of the three-phase alternating currents is 0. The three-phase current of the synchronous motor 200 may be obtained from the current flowing through a DC bus (not illustrated) on the input side of the power converter 300. With these configurations, the number of current sensors can be reduced, and cost reduction can be achieved.

Based on the three-phase currents IU, IV, and IW detected with the current detection unit 500, the magnetic pole position estimation unit 600 estimates an initial magnetic pole position θest of the rotor of the synchronous motor 200 while the synchronous motor 200 is stopped. Details of the magnetic pole position estimation unit 600 while the synchronous motor 200 is stopped are described below.

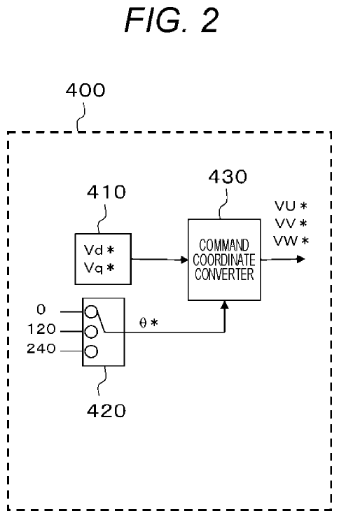

FIG. 2 is a detailed configuration diagram of the voltage pulse generation unit 400. This configuration diagram illustrates a configuration in a case where the initial magnetic pole position θest of the rotor of the synchronous motor 200 is estimated.

The voltage pulse generation unit 400 includes a voltage command generating unit 410, a phase switch 420, and a command coordinate conversion unit 430.

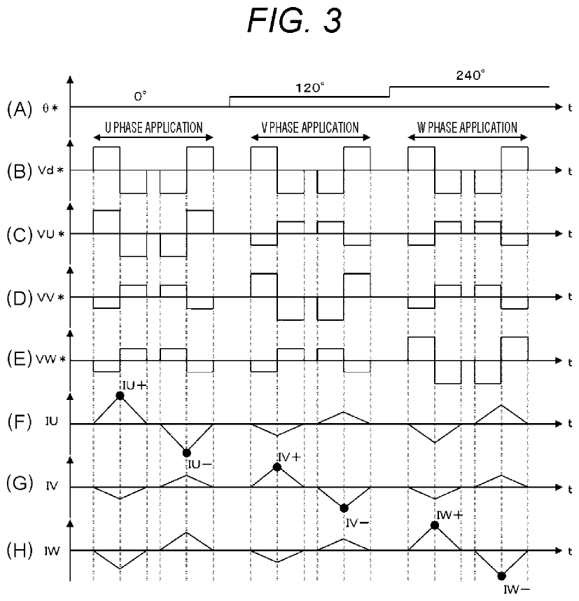

The voltage command generating unit 410 outputs the voltage commands Vd* and Vq*. In the present embodiment, Vd* alternating between positive and negative illustrated in FIG. 3(B) described below is generated, and Vq* is zero.

The phase switch 420 generates a phase reference value θ* for converting Vd* and Vq* generated by the voltage command generating unit 410 into three-phase voltage commands. As the phase reference values θ*, 0 degrees, 120 degrees, and 240 degrees are sequentially output.

The command coordinate conversion unit 430 receives the voltage commands Vd* and Vq* generated by the voltage command generating unit 410 and the phase reference values θ* output from the phase switch and converts coordinates thereof into the three-phase voltage commands VU*, VV*, and VW*. The coordinates are converted by Expressions (1), (2), and (3).

VU*=⅔×(Vd*×cos(θ*)−Vq*×sin(θ*)) (1)

VV*=⅔×(Vd*×cos(θ*−2π/3)−Vq*×sin(θ*−2π/3)) (2)

VW*=⅔×(Vd*×cos(θ*−4π/3)−Vq*×sin(θ*−4π/3)) (3)

FIGS. 3(A) to 3(H) are diagrams illustrating a relationship between the three-phase voltage commands VU*, VV*, and VW* and the three-phase currents IU, IV, and IW flowing through the synchronous motor 200. FIG. 3(A) illustrates the phase reference value θ* output from the phase switch 420 and FIG. 3(B) illustrates the voltage command Vd* generated by the voltage command generating unit 410. FIGS. 3(C) to 3(E) illustrate the three-phase voltage commands VU*, VV*, and VW* output from the command coordinate conversion unit 430, respectively. FIGS. 3(F) to 3(H) illustrate the three-phase currents IU, IV, and IW detected by the current detection unit 500 and input to the magnetic pole position estimation unit 600, respectively.

As illustrated in FIG. 3(A), the phase reference values θ* are output by the phase switch 420 in the order of 0 degrees, 120 degrees, and 240 degrees. As illustrated in FIGS. 3(C) to 3(E), the three-phase voltage commands VU*, VV*, and VW*, which are outputs of the command coordinate conversion unit 430 are applied as voltages that alternate between positive and negative, in the U phase when the phase reference value θ* is 0 degrees, in the V phase when the phase reference value θ* is 120 degrees, and in the W phase when the phase reference value θ* is 240 degrees. As a result, as illustrated in FIGS. 3(F) to 3(H), the three-phase currents IU, IV, and IW flow through the synchronous motor 200.

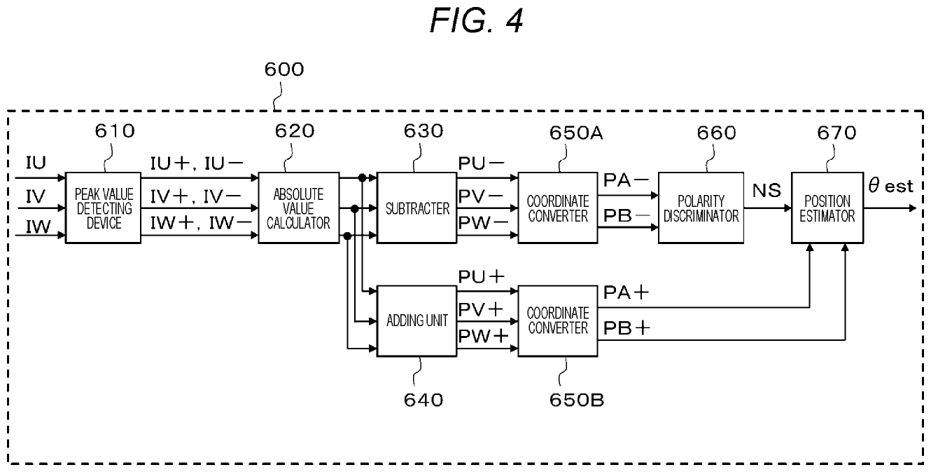

FIG. 4 is a detailed configuration diagram of the magnetic pole position estimation unit 600.

The magnetic pole position estimation unit 600 includes a peak value detector 610, an absolute value calculation unit 620, a subtraction unit 630, an addition unit 640, coordinate conversion units 650A and 650B, a polarity discriminator 660, and a position estimator 670.

The peak value detector 610 receives the current values IU, IV, and IW detected by the current detection unit 500 and detects current peak values IU+, IU−, IV+, IV−, IW+, and IW− of the respective phases.

In FIG. 3(F), the current peak IU+ is the maximum value of the U-phase current when a positive voltage is applied to the U phase with the phase reference value θ* of 0 degrees. In FIG. 3(F), the current peak IU− is the minimum value of the U-phase current when a negative voltage is applied to the U phase with the phase reference value θ* of 0 degrees.

In FIG. 3(G), the current peak IV+ is the maximum value of the V-phase current when a positive voltage is applied to the V phase with the phase reference value θ* of 120 degrees. In FIG. 3(G), the current peak IV− is the minimum value of the V-phase current when a negative voltage is applied to the V phase with the phase reference value θ* of 120 degrees.

In FIG. 3(H), the current peak IW+ is the maximum value of the W-phase current when a positive voltage is applied to the W phase with the phase reference value θ* of 240 degrees. In FIG. 3(H), the current peak IW− is the minimum value of the W-phase current when a negative voltage is applied to the W phase with the phase reference value θ* of 240 degrees.

The absolute value calculation unit 620 uses the current peak values IU+, IU−, IV+, IV−, IW+, and IW− in the respective phases as inputs, and calculates the respective absolute values.

The subtraction unit 630 calculates differences between absolute values of the current peak values of the respective phases by Expressions (4), (5), and (6), and outputs PU−, PV−, and PW−.

PU−=|IU+|−|IU−| (4)

PV−=|IV+|−|IV−| (5)

PW−=|IW+|−|IW−| (6)

Since PU−, PV−, and PW− are respective differences of absolute values of the current values when the positive voltage is applied and the current values when the negative voltage is applied, PU−, PV−, and PW− are values indicating the degree of magnetic saturation of the synchronous motor 200.

The coordinate conversion unit 650A converts PU−, PV−, and PW−, which are the differences between the absolute values of the current peak values in the respective phases by Expressions (7) and (8) and outputs results as PA− and PB−.

PA−=⅔×((PU−)−½×(PV−)−½×(PW−)) (7)

PB−=⅔×(√(3)/2×(PV−)−√(3)/2×(PW−)) (8)

Here, a case where initial magnetic pole positions are estimated by using the magnetic saturation characteristics of the synchronous motor 200 by calculating the difference between the absolute values of the current peak values is described. For example, in the technique described in PTL 1, after a positive voltage is applied to the U phase, a negative voltage is applied to the U phase to acquire the respective current peak values. Similarly, a positive voltage and a negative voltage are applied to the V phase and the W phase to acquire respective current peak values. Initial magnetic pole positions are estimated by using the magnetic saturation characteristics of a PM motor by calculating the difference between the absolute values of these current peak values.

In this case, for example, if a positive voltage is applied to the U phase when the initial magnetic pole position is close to the U phase, a magnetic flux due to the current flowing through the U phase and a magnetic flux due to the permanent magnet are in the same direction, so that the magnetic flux becomes excessive, and magnetic saturation occurs. When magnetic saturation occurs, the inductance of the synchronous motor 200 decreases, so that the current value increases.

As described above, when the technique disclosed in PTL 1 is used, a degree of magnetic saturation does not occur in a sinusoidal shape with respect to an initial magnetic pole position, and the degree of magnetic saturation is a non-sinusoidal wave, so that a large error occurs in the estimation of the initial magnetic pole position of the rotor.

In the present embodiment, as illustrated in FIG. 4, the addition unit 640, the coordinate conversion unit 650B, the polarity discriminator 660, and the position estimator 670 are newly provided.

As a result, for example, if a positive voltage is applied to the U phase when the initial magnetic pole position is close to the U phase, a magnetic flux due to the current flowing through the U phase and a magnetic flux due to the permanent magnet are in the same direction, but if a negative voltage is applied to the U phase, the magnetic flux due to the permanent magnet and the magnetic flux due to the current flowing through the U phase are in opposite directions to each other, and thus magnetic saturation does not occur. That is, the absolute value of the current peak value changes depending on whether a positive voltage or a negative voltage is applied to the U phase. Therefore, by obtaining the difference between the absolute value of the current peak value when a positive voltage is applied to each phase and the absolute value of the current peak value when a negative voltage is applied to each phase, the degree of the magnetic saturation characteristic of the synchronous motor 200 can be obtained, and the initial magnetic pole position of the rotor is estimated based on this degree.

The addition unit 640 illustrated in FIG. 4 adds the absolute values of the current peak values IU+, IU−, IV+, IV−, IW+, and IW− of the respective phases output from the absolute value calculation unit 620 for the respective phases by Expressions (9), (10), and (11) and outputs results as PU+, PV+, and PW+.

PU+=|IU+|+|IU−| (9)

PV+=|IV+|+|IV−| (10)

PW+=|W+|+|IW−| (11)

The coordinate conversion unit 650B has a configuration similar to that of the coordinate conversion unit 650A and converts PU+, PV+, and PW+ into PA+ and PB+ by Expressions (12) and (13) to output PA+ and PB+.

PA+=⅔×((PU+)−½×(PV+)−½×(PW+)) (12)

PB+=⅔×(√(3)/2×(PV+)−√(3)/2×(PW+)) (13)

Since PU+, PV+, and PW+ are obtained by adding the absolute values of the current peak values, PU+, PV+, and PW+ are equivalent to the peak-to-peak values (that is, amplitudes of the currents) of the current illustrated in FIGS. 3(F) to 3(H). In general, a permanent magnet-type synchronous motor frequently used in an electric vehicle has rotation angle dependency (saliency) of inductance. Since the inductance changes depending on the rotation angle (=initial magnetic pole position), the peak-to-peak value of the current in the present embodiment also changes depending on the initial magnetic pole position. In addition, even when the degree of magnetic saturation is in a non-sinusoidal shape, the influence is canceled by obtaining the peak-to-peak value of the current, and a change in inductance due to saliency appears as a change in the peak-to-peak value of the current. Therefore, even when the degree of magnetic saturation is in a non-sinusoidal shape, the initial magnetic pole position of the rotor can be estimated with higher accuracy.

Meanwhile, in general, in the synchronous motor 200, it is known that the change in inductance due to saliency appears at a cycle of ½ times the rotation angle. That is, in a method using the saliency, the initial magnetic pole position can be estimated only in the range of 0 to 180 degrees, and whether the polarity of the magnet of the rotor is the N pole or the S pole cannot be discriminated.

In the present embodiment, the polarity discriminator 660 is provided to discriminate the polarity of the magnet of the rotor. The polarity discriminator 660 uses PA− and PB− obtained from the degree of magnetic saturation as inputs to calculate a first magnetic pole position θest1 by Expression (14).

θest1=a tan((PB−)/(PA−)) (14)

Since the first magnetic pole position θest1 obtained from the degree of magnetic saturation can be estimated in the range of 0 to 360 degrees (that is, including the polarity of the magnet of the rotor), the polarity is thereby discriminated and output as a polarity NS. When the first magnetic pole position θest1 is within a predetermined range, the polarity is determined as the N pole, and when the first magnetic pole position θest1 is out of the predetermined range, the polarity is determined as the S pole. Here, the predetermined range is, for example, a range in which the first magnetic pole position θest1 is 0 to 180 degrees. Specifically, when the first magnetic pole position is 0 to 180 degrees, the polarity is determined as the N pole, and when the first magnetic pole position is 180 to 360 degrees, the polarity is determined as the S pole.

The position estimator 670 calculates the initial magnetic pole position θest using the polarity NS and PA+ and PB+ obtained from the current peak-to-peak values of the respective phases as inputs. First, the position estimator 670 estimates a second magnetic pole position θest2 by Expression (15) based on PA+ and PB+.

θest2=a tan(−(PA+)/(PB+)) (15)

The second magnetic pole position θest2 can be obtained only in the range of 0 to 180 degrees, and the polarity NS which is the discrimination result by the polarity discriminator 660 is used for this. When the polarity NS is determined as the N pole, the second magnetic pole position θest2 is output as it is as the initial magnetic pole position θest. Meanwhile, when the polarity NS is determined as the S pole, a value obtained by adding 180 degrees to the second magnetic pole position θest2 is output as the initial magnetic pole position θest.

According to the present embodiment, the peak values of the currents when the positive and negative voltages are sequentially applied to respective phases of the synchronous motor 200 by the voltage pulse generation unit 400 are detected to calculate subtracted values and added values of the absolute values of the current peak values. The degree of magnetic saturation is extracted from the subtraction of the absolute value, and the amplitude change of the current due to the saliency is obtained from the addition of the absolute value. Therefore, the degree of magnetic saturation and the change in amplitude of the current due to saliency can be simultaneously obtained. In addition, whether the polarity of the magnet of the rotor is the N pole or the S pole can be discriminated from the degree of magnetic saturation, and the initial magnetic pole position θest of the rotor can be accurately estimated by canceling the influence of magnetic saturation from the amplitude change of the current caused by the saliency. Therefore, in the present embodiment, without changing the time required for estimating the initial magnetic pole position θest from that in the related art, the estimation accuracy can be improved. Since the initial magnetic pole position θest can be estimated with high accuracy, sensorless control of the synchronous motor 200 can also be performed with high accuracy. For example, even when the synchronous motor 200 is used in an electric vehicle, the control performance as a main motor is improved, and comfortable ride can be provided to the occupant.

### Second Embodiment

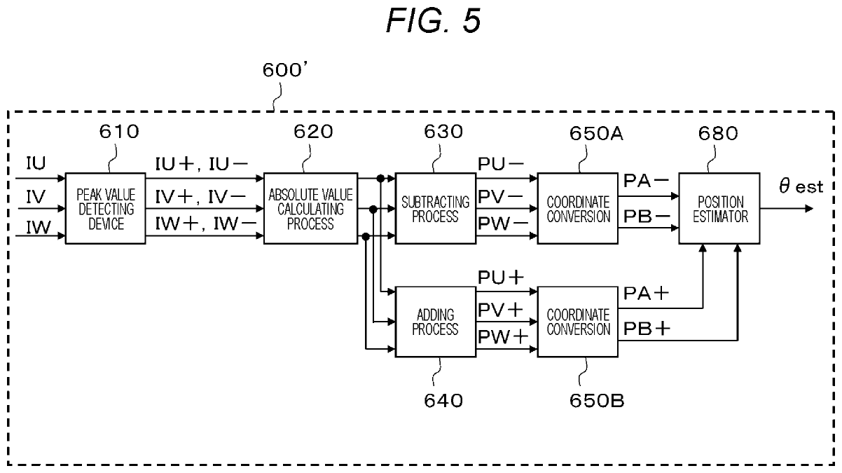

FIG. 5 is a detailed configuration diagram of a magnetic pole position estimation unit 600′ according to the embodiment. The same portions as those of the magnetic pole position estimation unit 600 in the first embodiment are denoted by the same reference numerals, and the descriptions thereof are omitted. The configuration diagram of the drive device 100 of the synchronous motor 200 illustrated in FIG. 1, the detailed configuration diagram of the voltage pulse generation unit 400 illustrated in FIG. 2, and the diagram illustrating the relationship between the three-phase voltage command and the three-phase current illustrated in FIG. 3 are the same in the present embodiment.

In the first embodiment, only the first magnetic pole position is used for polarity discrimination, but in the present embodiment, the polarity NS is obtained from the first magnetic pole position and the second magnetic pole position.

In the present embodiment, as illustrated in FIG. 5, the magnetic pole position estimation unit 600′ includes a position estimator 680. To the position estimator 680, PA− and PB− are input from the coordinate conversion unit 650A, and PA+ and PB+ are input from the coordinate conversion unit 650B.

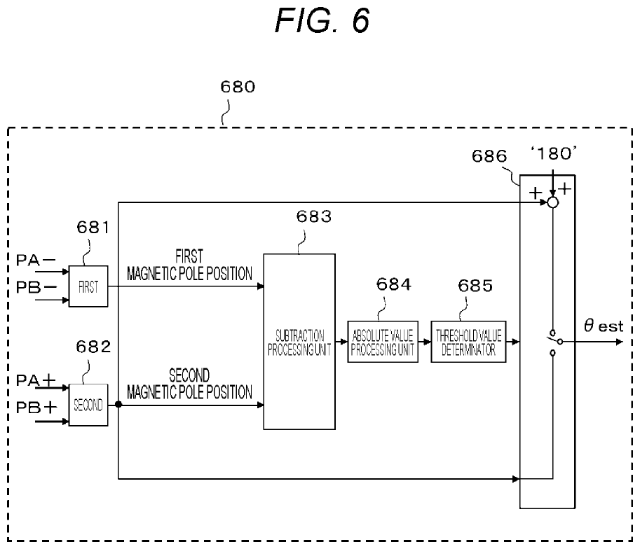

FIG. 6 is a detailed configuration diagram of the position estimator 680. The position estimator 680 includes a first magnetic pole position calculation unit 681, a second magnetic pole position calculation unit 682, a subtraction processing unit 683, an absolute value processing unit 684, a threshold determination unit 685, and an initial magnetic pole position calculation unit 686.

The first magnetic pole position calculation unit 681 calculates the first magnetic pole position θest1 by Expression (14) by using PA− and PB− as inputs. The second magnetic pole position calculation unit 682 calculates the second magnetic pole position θest2 by Expression (15) by using PA+ and PB+ as inputs.

The subtraction processing unit 683 obtains a difference between the first magnetic pole position θest1 and the second magnetic pole position θest2. The absolute value processing unit 684 obtains an absolute value of the difference between the first magnetic pole position θest1 and the second magnetic pole position θest2. Then, the threshold determination unit 685 determines that the polarity is the S pole when the absolute value of the difference between the first magnetic pole position θest1 and the second magnetic pole position θest2 is within a predetermined range, and determines that the polarity is the N pole when the absolute value is out of the predetermined range. Here, the predetermined range may be set in consideration of the error of the first magnetic pole position θest1, and is, for example, a range in which the absolute value of the difference between the first magnetic pole position θest1 and the second magnetic pole position θest2 is 90 to 270.

The initial magnetic pole position calculation unit 686 outputs a value obtained by adding 180 degrees to the second magnetic pole position θest2 when the polarity is determined as the S pole by the threshold determination unit 685 and outputs the second magnetic pole position θest2 as the initial magnetic pole position θest when the polarity is determined as the N pole.

Here, as described in the first embodiment, when the polarity NS is discriminated only from the first magnetic pole position θest1, the accuracy of the first magnetic pole position θest1 is low, and thus there is a concern that the polarity NS is incorrect. If the polarity is determined as the N pole when the first magnetic pole position θest1 is 0 to 180 degrees and determined as the S pole when the first magnetic pole position θest1 is 180 to 360 degrees, there is an error in the initial magnetic pole position θest and the first magnetic pole position θest1, and there is a concern that the polarity is incorrect when the initial magnetic pole position θest is near 180 degrees or near 360 degrees.

Meanwhile, as described in the present embodiment, by discriminating the polarity NS from the first magnetic pole position θest1 and the second magnetic pole position θest2, an error in the first magnetic pole position θest1 can be considered, and thus the initial magnetic pole position θest of the rotor can be estimated without an error in the polarity NS.

### Third Embodiment

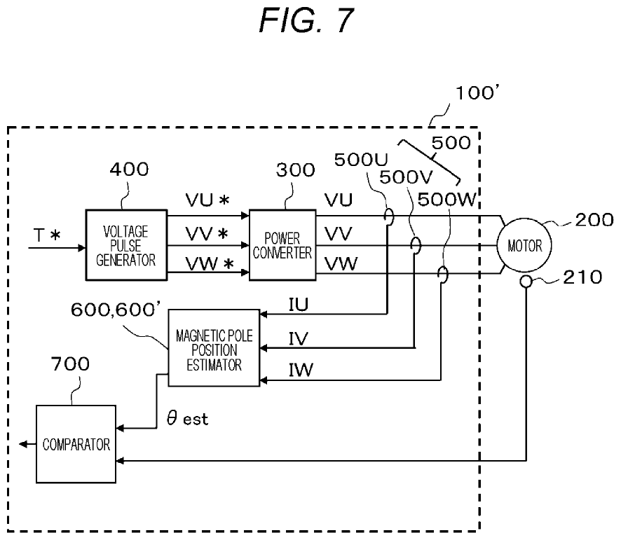

FIG. 7 is a configuration diagram of a drive device 100′ according to the present embodiment. The same portions as those in the configuration diagram of the drive device 100 in the first embodiment illustrated in FIG. 1 are denoted by the same reference numerals, and the descriptions thereof are omitted.

In the present embodiment, the synchronous motor 200 includes a position sensor 210 that detects a magnetic pole position of the synchronous motor 200. The magnetic pole position detected by the position sensor 210 is input to one side of a comparison unit 700. The initial magnetic pole position θest estimated by the magnetic pole position estimation unit 600 or the magnetic pole position estimation unit 600′ described in the first embodiment or the second embodiment is input to the other side of the comparison unit 700. The comparison unit 700 compares the estimated initial magnetic pole position θest with the magnetic pole position detected by the position sensor 210 while the synchronous motor 200 is stopped, and determines the presence or absence of the abnormality of the position sensor 210 based on the comparison result.

The position sensor 210 such as a resolver may fail due to disconnection or short circuit of the output winding. When the synchronous motor 200 is rotating, the failure can be detected, but, while the synchronous motor 200 is stopped, it is difficult to detect the failure. Since the magnetic pole position estimation units 600 and 600′ described in the first embodiment or the second embodiment can estimate the initial magnetic pole position θest while the synchronous motor 200 is stopped, a failure of the position sensor 210 can be detected even when the synchronous motor 200 is stopped. As a result, it is possible to provide the drive device 100′ of the synchronous motor 200 with higher reliability.

In the first to third embodiments, the voltage pulse generation unit 400, the magnetic pole position estimation units 600 and 600′, the comparison unit 700, and the like are described as hardware, but the functions thereof may be embodied by a computer and a program. Then, the program can be executed by a computer including a CPU, a memory, and the like. All or a part of the processing may be embodied by a hard logic circuit. Furthermore, the program may be supplied as various forms of computer-readable computer program products such as a storage medium and a data signal (carrier wave).

According to the embodiment described above, the following operational effects can be obtained.

(1) The drive devices 100 and 100′ of the synchronous motor 200 include the power converter 300 that drives the synchronous motor 200 by sequentially applying positive and negative voltages to the respective phases of the synchronous motor 200, the current detection unit 500 that detects a phase current flowing through the synchronous motor 200, and the magnetic pole position estimation units 600 and 600′ that estimate a magnetic pole position of the rotor of the synchronous motor 200 based on the phase current detected by the current detection unit 500. Then, the magnetic pole position estimation units 600 and 600′ acquire the maximum value and the minimum value of the phase current while the synchronous motor 200 is stopped, calculate the first magnetic pole position θest1 from the subtracted value of the respective absolute values of the maximum value and the minimum value, calculate the second magnetic pole position θest2 from the added value of the respective absolute values of the maximum value and the minimum value, discriminate the polarity of the magnet of the rotor from the first magnetic pole position θest1, and estimate the initial magnetic pole position θest of the rotor of the synchronous motor 200 from the polarity and the second magnetic pole position θest2. As a result, the initial magnetic pole position θest of the rotor of the rotor of the synchronous motor 200 can be estimated with high accuracy while the synchronous motor 200 is stopped.

(2) A method of driving the synchronous motor 200 is a method of driving the synchronous motor 200 in the drive devices 100 and 100′ of the synchronous motor 200 including the power converter 300 that drives the synchronous motor 200 by sequentially applying positive and negative voltages to the respective phases of the synchronous motor 200 and the current detection unit 500 that detects a phase current flowing through the synchronous motor 200, in which the method includes: acquiring a maximum value and a minimum value of the phase current while the synchronous motor 200 is stopped; calculating a first magnetic pole position θest1 from a subtracted value of an absolute value of each of the maximum value and the minimum value; calculating a second magnetic pole position θest2 from an added value of an absolute value of each of the maximum value and the minimum value; discriminating a polarity of a magnet of a rotor of the synchronous motor 200 from the first magnetic pole position θest1; and estimating the initial magnetic pole position θest of the rotor of the synchronous motor 200 from the polarity and the second magnetic pole position θest2. As a result, the initial magnetic pole position θest of the rotor of the rotor of the synchronous motor 200 can be estimated with high accuracy while the synchronous motor 200 is stopped.

The present invention is not limited to the embodiments described above, and other forms conceivable within the scope of the technical idea of the present invention are also included within the scope of the present invention without departing from the features of the present invention. In addition, a part of the configuration of a certain embodiment may be replaced with the configuration of another embodiment, or the configuration of another embodiment may be added to the configuration of a certain embodiment.

### REFERENCE SIGNS LIST

100, 100′ drive device
200 synchronous motor
300 power converter
400 voltage pulse generation unit
410 voltage command generating unit
420 phase switch
430 command coordinate conversion unit
500 current detection unit
600, 600′ magnetic pole position estimation unit
610 peak value detector
620 absolute value calculation unit
630 subtraction unit
640 addition unit
650A, 650B coordinate conversion unit
660 polarity discriminator
670 position estimator
680 position estimator
681 first magnetic pole position calculation unit
682 second magnetic pole position calculation unit
683 subtraction processing unit
684 absolute value processing unit
685 threshold determination unit
686 initial magnetic pole position calculation unit

1. A drive device of a synchronous motor comprising:
a power converter that drives the synchronous motor by sequentially applying positive and negative voltages to respective phases of the synchronous motor;
a current detection unit that detects a phase current flowing through the synchronous motor; and
a magnetic pole position estimation unit that estimates a magnetic pole position of a rotor of the synchronous motor based on the phase current detected by the current detection unit,
wherein the magnetic pole position estimation unit acquires a maximum value and a minimum value of the phase current while the synchronous motor is stopped, calculates a first magnetic pole position from a subtracted value of an absolute value of each of the maximum value and the minimum value, calculates a second magnetic pole position from an added value of the absolute value of each of the maximum value and the minimum value, discriminates a polarity of a magnet of the rotor from the first magnetic pole position, and estimates an initial magnetic pole position of the rotor of the synchronous motor from the polarity and the second magnetic pole position.

2. The drive device of the synchronous motor according to claim 1,
wherein the magnetic pole position estimation unit discriminates a polarity of the magnet from the first magnetic pole position and the second magnetic pole position and estimates an initial magnetic pole position of the rotor of the synchronous motor from the polarity and the second magnetic pole position.

3. The drive device of the synchronous motor according to claim 1,
wherein the synchronous motor includes a position sensor that detects the magnetic pole position of the synchronous motor,
the drive device of the synchronous motor includes a comparison unit that compares the initial magnetic pole position obtained by the magnetic pole position estimation unit with the magnetic pole position obtained by the position sensor, and
the comparison unit determines presence or absence of abnormality of the position sensor based on a comparison result obtained by the comparison unit while the synchronous motor is stopped.

4. A method of driving a synchronous motor by a drive device of the synchronous motor that includes a power converter that drives the synchronous motor by sequentially applying positive and negative voltages to respective phases of the synchronous motor, and a current detection unit that detects a phase current flowing through the synchronous motor, the method comprising:
acquiring a maximum value and a minimum value of the phase current detected by the current detection unit while the synchronous motor is stopped;
calculating a first magnetic pole position from a subtracted value of an absolute value of each of the maximum value and the minimum value;
calculating a second magnetic pole position from an added value of the absolute value of each of the maximum value and the minimum value;
discriminating a polarity of a magnet of the rotor of the synchronous motor from the first magnetic pole position; and
estimating an initial magnetic pole position of the rotor of the synchronous motor from the polarity and the second magnetic pole position.
